(19) United States
(12) Patent Application Publication
(10) Pub. No.: US 2009/0028179 A1
(43) Pub. Date: Jan. 29, 2009

(54) STORING DEVICE CAPABILITY INFORMATION IN AN ADDRESS BOOK

(75) Inventor: Nandakishore A. Albal, Scottsdale, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/828,405

(22) Filed: Jul. 26, 2007

(51) Int. Cl. H04J 3/16

(52) U.S. Cl. 370/465

(57) ABSTRACT

A method (300) and a system (100) for providing device capability information. The method can include receiving from a first communication device (106) at least a first identifier (110) that indicates functional capabilities of the first communication device, and automatically associating in an address book (112) the functional capabilities of the first communication device with a contact with whom the first device is associated. The method further can include determining whether a first communication device is authorized to receive a first identifier that indicates functional capabilities of a second communication device (104) in response to an event. The first identifier can be automatically communicated to the first communication device in response to determining that the first communication device is authorized to receive the first identifier.

### BACKGROUND OF THE INVENTION

1. Field of the Invention

The present invention generally relates to communications systems and, more particularly, to the use of address books within a communications network.

2. Background of the Invention

A network address book is an electronic address book that contains contact information which may be accessed via a communications network, for instance via the Internet, and is typically implemented using a centralized data storage application that may be accessed by one or more suitably configured electronic devices. Thus, rather than being limited to a single device, a user can store and retrieve contact information from a network address book using a plurality of devices. For example, the user may access a network address book from a work computer, a home computer, a personal digital assistant and a mobile telephone. In some instances the network address book can be accessed from any device having an Internet browser or a suitably configured application.

Notwithstanding the convenience that network address books provide to users, the information that they provide tends to be somewhat limited. For example, a typical network address book may only provide basic contact information, such as a name, a job title, a company, telephone numbers, addresses, e-mail addresses, a web page address and an instant messaging address. Some network address books also provide location information. Such information often is inadequate, however, to insure that a contact may be reached at a particular moment using a preferred method of communication. For example, a user may not know what communication services are presently available to a contact with whom the user wishes to communicate.

### SUMMARY OF THE INVENTION

The present invention relates to a method of providing device capability information. The method can include receiving from a first communication device at least a first identifier that indicates functional capabilities of the first communication device, and automatically associating in an address book the functional capabilities of the first communication device with a contact with whom the first device is associated.

In another arrangement, the method can include determining whether a first communication device is authorized to receive a first identifier that indicates functional capabilities of a second communication device in response to an event. The method also can include automatically communicating the first identifier to the first communication device in response to determining that the first communication device is authorized to receive the first identifier.

The present invention also relates to a communication device. The communication device can include at least one communications adapter that receives from a second communication device at least a first identifier that indicates functional capabilities of the second communication device. The communication device also can include a controller that automatically associates in an address book the functional capabilities of the second communication device with a contact with whom the second communication device is associated.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a communication device that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to sharing information related to a communication device's functional capabilities such that the information can be accessed by other communication devices. Based on the functional capability information, the other communication devices and/or users of such devices can select a preferred mode of communication for communicating with the communication device.

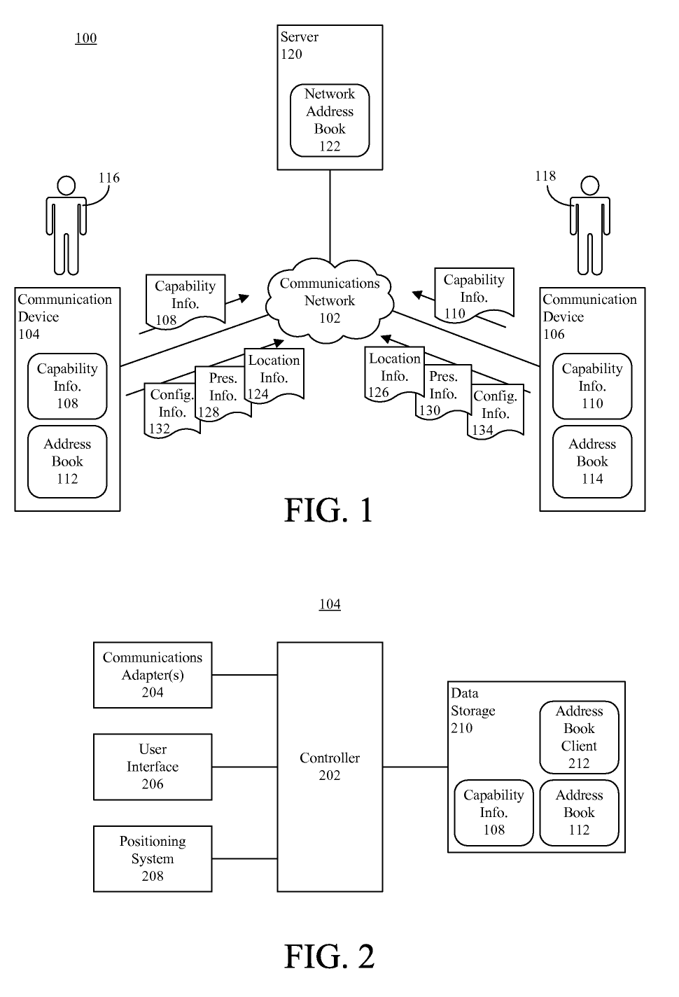

FIG. 1 depicts a communications system 100 that is useful for understanding the present invention. The communications system 100 can include a communications network 102, which may comprise any suitable network infrastructure, for example a wide area network (WAN), such as the Internet, the World Wide Web, a cellular communications network, a public switched telephone network (PSTN), and the like. Other examples of suitable network infrastructure may include, but are not limited to, a radio access network (RAN), a local area network (LAN), a metropolitan area network (MAN), a WiFi network, a Mesh network, a public safety network (e.g. Astro, TETRA, HPD, etc.) and/or any other networks or systems over which communication signals can be propagated. In that regard, the communications network 102 can include wired and/or wireless communication links.

The communications network 102 can be configured to communicate data via IEEE 802 wireless communications, for example, 802.11 and 802.16 (WiMAX), 3G, 4G, WPA, WPA2, GSM, TDMA, CDMA, WCDMA, OFDM, direct wireless communication, or any other communications format. Indeed, the communications network 102 can be implemented in accordance with any suitable communications standards, protocols, and/or architectures, or a suitable combination of such standards, protocols, and/or architectures.

The communications system 100 also can include one or more communication devices 104, 106 which communicate via the communications network 102. The communication devices 104, 106 can be, for instance, mobile stations (e.g. mobile telephones, mobile radios, mobile computers, personal digital assistants, or the like), computers, set top boxes, wireless gaming devices, access terminals, subscriber stations, gaming consoles, user equipment, or any other devices suitably configured to communicate via the communications network 102. As such, the communication devices 104, 106 can comprise one or more processors/controllers, data storage devices, user interfaces, communication adapters (e.g. transceivers, network adapters, etc.), and/or other suitable components.

One, or both, of the communication devices 104, 106 can store information 108, 110 related to their respective functional capabilities. For example, the capability information 108 can comprise information which indicates various modes of operation with which the communication device 104 is capable of communicating. Similarly, the capability information 110 can indicate various modes of operation with which the communication device 106 is capable of communicating. Such modes of operation can comprise voice communication modes, video communication modes, text communication modes, and the like. Examples of such communication modes can include, but are not limited to, text messaging, instant messaging, full duplex voice communications, one-half duplex voice communications and video communications. Different modes of communication also can be distinguished by the various communication protocols that are implemented by the communication devices 104, 106. For instance, a first communication mode can be a mode in which the communication device 104 communicates via a first communications network (e.g. a cellular communications network), and a second communication mode can be a mode in which the communication device 104 communicates via a second communications network (e.g. via an access point of a WiMax network). Still, the different communication modes can be distinguished in any other suitable manner and the invention is not limited in this regard.

In one arrangement, the capability information 108, 110 can comprise identifiers that identify a model and/or manufacturer of the respective communication devices 104, 106. For example, the capability information 108 can indicate a model number of the communication device 104 and the capability information 110 can indicate a model number of the communication device 106. One or more data tables or data files (not shown) can correlate the identifiers to communication modes that the respective communication devices 104, 106 are capable of supporting. In another arrangement, public sources, such as manufacturer web sites, can be accessed to retrieve the capability information 108, 110 using the indicated model numbers. Once capability information 108, 110 for a particular communication device has been retrieved, such capability information 108, 110 can be automatically associated with other equivalent communication devices that are added to an address book 112, 114 without the need to again retrieve the information.

The capability information 108, 110 also can include user preferences. For instance, if the communication device 106 has both dispatch (e.g. half-duplex) and interconnect (e.g. full duplex) voice communication capabilities, but the user 118 prefers dispatch communications, the capability information 110 can indicate that dispatch communications are preferred over interconnect communications. Similarly, if the user 116 prefers video conferencing while the user 116 is located at work, the capability information 108 can indicate such preference. Any other communication preferences can be contained in the capability information 108, 110 as well.

The communication devices 104, 106 further can comprise respective electronic address books 112, 114. The address book 112 can contain information related to contacts of a user 116 of the communication device 104, and the address book 114 can contain information related to contacts of a user 118 of the communication device 106. For example, if the user 118 is a contact of the user 116, contact information for the user 118 can be contained in the address book 112. Likewise, if the user 116 is a contact of the user 118, contact information for the user 116 can be contained in the address book 114.

Optionally, the communications system 100 also may include a server 120. The server 120 can be a web server, a network server, a domain server, a file server, a base station controller, a component of a mobile switching center (MSC), or any other suitable server. As such, the server 120 can comprise one or more processors/controllers, data storage devices, user interfaces, communication adapters, and/or other suitable components.

A network address book 122 can be associated with the server 120. For example, the network address book 122 can be stored on the server 120 or otherwise accessed by the server 120. The network address book 122 can be provided in addition to, or in lieu of, the address book 112 and/or the address book 114. For example, in lieu of the address book 112, the user 116 can utilize the network address book 122. Alternatively, the user 116 can use the address book 112, and the address book 112 can automatically synchronize with the network address book 122. For instance, the network address book 122 can comprise data that associates communication devices 104, 106 with their capabilities and their respective users 116, 118, and such information can be communicated to the communication devices 104, 106 to populate the respective address books 112, 114 or update existing information contained in the respective address books 112, 114. The address books 112, 114 can be updated periodically, or in response to an event, such as initiation of a communication session or a request to change the content of the address books 112, 114. In this arrangement, when the user 116 uses another communication device (not shown), the user 116 can access the capability information 108 via the network address book 122.

If the user 118 is listed as a contact in the address book 112 and/or the network address book 122, during operation the communication device 106 can communicate the capability information 110 to the communication device 104 and/or to the server 120. Such communication can be performed in any suitable manner. For example, the communication device 106 can communicate the capability information 110 to the communication device 104 and/or to the server 120 in response to receiving a message requesting the capability information 110, for instance during a communication session. Such request can be sent by the communication device 104 or the server 120.

In another arrangement, communication of the capability information 110 can be performed during call setup of the communication device 106, or during logon to a communications network, such as the communications network 102. For example, the communication can be performed using a suitable signaling protocol, such as session initiation protocol (SIP).

In yet another arrangement, the server 120 can solicit the capability information 110 from the communication device 106, for instance by sending a request to the communication device, and store the capability information in the network address book 122. Such a request can be communicated during call setup of the communication device 106 or during logon to a communications network.

The communication device 104 also can communicate the capability information 108 to the communication device 104 and/or to the server 120 in any suitable manner so that the capability information may be entered into the address book 112 and/or the network address book 122. For example, the capability information 108 can be communicated to the communication device 104 and/or to the server 120 in accordance with the examples previously described with respect to the communication device 106 and the capability information 110.

The communication device 104 can store the capability information 110 in the address book 112 and associate the capability information 110 with the user 118, who is the contact associated with the communication device 106. Similarly, the communication device 106 can store the capability information 108 in the address book 114 and associate the capability information 108 with the user 116, who is the contact associated with the communication device 104. If capability information 108 and/or capability information 110 is communicated to the server 120, the server 120 can store the capability information 108, 110 in the network address book 122 and associate the capability information 108, 110 with the respective users 116, 118. Alternatively, the server 120 can receive the capability information from the address books 112, 114 when the address books 112, 114 are synchronized with the network address book 122.

If a particular user is associated with multiple communication devices, the address books 112, 114 and/or the network address book 122 can maintain capability information for each of a user's communication devices. As such, the address books 112, 114 and/or the network address book 122 can act as a central repository for information associated with various communication devices used by a particular contact. Further, such information can be categorized in any desired manner to facilitate accessing the information from the address books 112, 114 and/or the network address book 122. For instance, the information can be segmented by device, category (e.g. personal or business), contact relationship, and so on.

In addition to the capability information, other information also can be communicated and maintained in the same manner as the capability information 108, 110. For instance, the communication device 104 can communicate location information 124 to the communication device 106 and/or the server 120 to be associated with the user 116 in the address book 114 and/or network address book 122, and the communication device 106 can communicate location information 126 to the communication device 104 and/or the server 120 to be associated with the user 118 in the address book 112 and/or network address book 122. The location information 124, 126 can indicate the present locations of the communication devices, respectively, and can be generated using a location positioning system, a global positioning system, an IP address, a network identifier, or generated in any other suitable manner. Of course, if the communication device 104 is presently being used by the user 116, the location information 124 can indicate the present location of the user 116. Similarly, the location information 126 can indicate the present location of the user 118 if the communication device 116 is presently being used by the user 118.

In an arrangement in which a user 118 uses a plurality of communication devices, each of which may be used at a different location, one or more of such devices can communicate their location information to the communication device 104 and/or the server 120. Such communication devices can communicate the location information in response to a request, call setup, network logon, or in response to any other desired event. Thus, the address books 112, 114 and/or the network address book 122 can maintain location information for each of a user's communication devices.

Optionally, the location information 124, 126 also can indicate communication services which are available at a location where the respective communication devices 104, 106 are located. For example, if the communication device 104 is located within a coffee shop that provides free broadband Internet access, the location information can indicate that such broadband Internet access is presently available to the communication device 104.

The communication devices 104, 106 also can communicate presence information 128, 130, which also can be stored in the address books 112, 114 and/or the network address book 122. The presence information 128, 130 can indicate a user's present availability for communication or present availability for a particular type of communication. For example, if a user 116 is at work, and while at work the user 116 does not wish to be contacted via mobile voice communications, the presence information 128, 130 can indicate that mobile voice communication with the user is presently unavailable. If the user 116 has entered a meeting and wishes not to be disturbed, the presence information 128, 130 can indicate that the user is currently unavailable. The presence information 128, 130 can be generated, maintained and communicated in the same manner in which the capability information 108, 110 and/or location information 124, 126 is generated, maintained and communicated.

Other device characteristics and settings also can be stored in the address books 112, 114 and/or the network address book 122. For example, information 132, 134 pertaining to the present configurations of the respective communication devices 104, 106 can be maintained. Such information 132, 134 can include, but is not limited to, current software versions, current firmware versions, service packs that have been applied, security updates that have been applied, virus file updates that have been applied, and so on. The configuration information 132, 134 can be generated, maintained and communicated in the same manner in which the capability information 108, 110 and/or location information 124, 126 is generated, maintained and communicated.

The configuration information 132, 134 can be provided to authorized users, for instance system administrators, who may analyze the information to determine whether the respective communication devices 104, 106 are properly configured. Such users can access the information by accessing the network address book 122 or the individual address books 112, 114. If the communication devices 104, 106 are not properly configured, software, firmware and/or virus updates can be communicated and installed on the communication devices 104, 106 using known techniques.

In one arrangement, information contained in the network address book 122 can be shared among multiple communication devices. For example, in response to the network address book 122 receiving updated information, or in response to receiving a request for updated information, the server 120 can propagate the updated information to the communication devices 104, 106 to be included in the respective address books 112, 114. In such an arrangement, each of the address books 112, 114 can be updated with information for all contacts contained in the address book 122. Alternatively, the address books 112, 114 can be exclusively updated with information correlating to contacts already contained in the respective address books 112, 114.

The communication of the capability information 108, 110, the location information 124, 126, the presence information 128, 130 and/or configuration information 132, 134 can remain unnoticeable to the users 116, 118. In another arrangement, the users 116, 118 can be prompted to indicate whether they wish to transmit or receive the capability information 108, 110, the location information 124, 126, the presence information 128, 130 and/or configuration information 132, 134.

Security settings can be applied to the sharing of the capability information 108, 110, location information 124, 126, the presence information 128, 130 and/or configuration information 132, 134. For instance, the communication device 104 can limit sharing of the capability information 108, location information 124, presence information 128 and/or configuration information 132 to authorized address books 114, 122, authorized users, such as the user 118, and/or authorized communication devices, for instance the communication device 106 and server 120. The authorized address books 114, 122, users 118 and/or devices 106, 120 can be identified to the communication device 104 or the user 116 in any suitable manner. For example, the authorized address books 114, 122, users 118 and/or devices 106, 120 can be contained in the address book 112, the network address book 122, or a security file that may be accessed by the communication device 104. Such security file can be a data file or data table stored on the communication device 104, the server 120, or in any other device that may be accessed by the communication device 104.

When the user 116 of the communication device 104 selects the user 118 in the address book 112 or the network address book 122, the communication device 104 can process the capability information 110 to select an appropriate mode of communication for communicating with the user 118. Such selection can be presented on the communication device 104. For example, if the communication device 104 has video conferencing capabilities, and the capability information 110 indicates that communication device 106 has video conferencing capability, the communication device 104 can present to the user 116 an indicator indicating that video conferencing with the user 118 is available via the communication device 106.

Selection of the mode of communication also can be based, at least in part, on the location information 124, 126 and/or the presence information 128, 130. Continuing with the previous example, if the capability information 110 indicates that the communication device 106 has video conferencing capabilities, but the location information 126 indicates that only a low bandwidth communication link is available to the communication device 106, the mode of communication that is selected may not be video conferencing. Instead, an audio or text communication mode may be selected as such communication modes may be better suited for communicating over a low bandwidth communication link. Similarly, if the location information 126 indicates that the communication device 106 is located within a moving vehicle, an audio communication mode may be selected since such mode may be less distracting to the user 118, who may be driving, than text or video mode. If the presence information indicates that the user 118 is presently unavailable, rather than attempting to establish communication with the user 118, the communication device 104 can indicate to the user 116 that the user 118 is unavailable.

In another aspect of the inventive arrangements, the communication device 104 can initiate communication with the user 118 by automatically selecting and using a communication mode based on the capability information 110, location information 126 and/or presence information 130. For instance, if the user 116 selects the user 118 from a contact list contained in the address book 112 or the network address book 122, based on the location information 126 and presence information 130, the communication device 104 can determine that the user 118 is presently available via his work telephone. Based on the capability information 110, the communication device 104 can determine that the user 118 prefers to be contacted via dispatch communications. Accordingly, when the user 116 initiates a communication session with the user 118, dispatch communications can automatically be used by the communication device 104 for the communication session.

FIG. 2 depicts a block diagram of a communication device 104 that is useful for understanding the present invention. The communication device 104 can include a controller 202. The controller 202 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 104 also can include one or more communication adapters 204 which the communication device 104 may use to communicate with other communication devices during communication sessions. For example, the communication device 104 can send and receive capability information, location information, presence information and configuration information via the communication adapter(s) 204. The communication device 104 also can communicate text, audio, video, or any other information communicated to or from the communication device 104 via the communication adapter(s) 204.

The communication adapters 204 can be any communication adapters compatible with one or more communications networks to which the communication device 104 may be communicatively linked. For example, a communication adapter 204 can include a transceiver that communicates signals in accordance with IEEE 802 wireless communications, for example, 802.11 and 802.16 (WiMax), WPA, WPA2, GSM, TDMA, CDMA, WCDMA, OFDM, Bluetooth, ZigBee, direct wireless communication, TCP/IP, or in accordance with any other communications protocol supported by a communications network with which the communication device 104 may be communicatively linked. In that regard, the communication adapter(s) 204 can communicate via wired and/or wireless communications links.

The communication device 104 also can include a user interface 206, which may comprise one or more tactile input devices, displays, input audio transducers, output audio transducers, and/or any other user interface devices. In addition, the communication device 104 can include a positioning system 208. The positioning system can include a global positioning system (GPS), a local positioning system, or any other system that can identify a location of the communication device 104. In one arrangement, the positioning system 208 can identify a location of the communication device by receiving an identifier from a communications network with which the communication device 104 is communicatively linked. For example, the positioning system 208 can include a positioning application that receives an identifier that identifies a work location, coffee shop, hotel, etc.

The communication device 104 further can include data storage 210. The data storage 210 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 210 can be integrated into the controller 202, though this need not be the case.

The previously described capability information 108, location information 124, presence information 128, configuration information 130 and address book 112 can be contained on the data storage 210. In an arrangement in which the communication device subscribes to a network address book, an address book client 212 also can be contained on the data storage 210. The controller 202 can instantiate/execute the address book client 212 to implement the processes and methods described herein that are performed by the communication device 104.

For example, the address book client 212 can receive capability information, location information, presence information and/or configuration information corresponding to another communication device. The address book client 212 also can store such information in the address book 112. For instance, the information can be associated with a contact in an address book. The address book client 212 also can select a mode of communication to use to communicate with the other communication device based on received information.

The address book client 212 also can forward the information 108, 124, 128, 132 to another communication device and/or to a server to be stored in a network address book. Further, the address book client 212 can synchronize a local address book with the network address book, receive contact information from the network address book, forward contact information to the network address book, and so on.

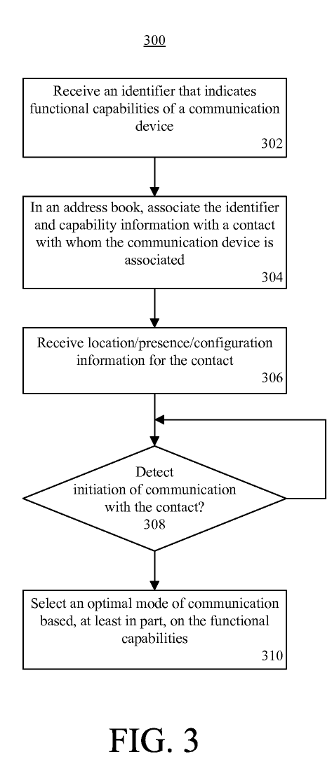

FIG. 3 is a flowchart that presents a method 300 that is useful for understanding the present invention. Beginning at step 302, an identifier that indicates functional capabilities of a communication device (e.g. a first communication device) can be received by a second communication device. Such information can be communicated by the first communication device in response to a request, during call setup of the communication device, or communicated in response to any other suitable event. At step 304 the identifier can be associated with a contact in an address book. The contact in the address book can be a contact associated with the first communication device. The address book can be an address book on a second communication device or a network address book.

Proceeding to step 306, location information, presence information and/or configuration information for the contact also can be received. Such information can be received from a communication device presently being used by the contact, which may be the first communication device that provided the capability information or another communication device. Proceeding to decision box 308, another communication device (e.g. the second communication device) can monitor for initiation of communication with the contact. Such initiation can be indicated, for instance, by a user selecting the contact from an address book and selecting a suitable communication action via a user interface on a second communication device.

Continuing to step 310, an optimal mode of communication can be selected for communicating with the contact. The optimal mode can be based, at least in part, on the functional capabilities of the first communication device. The optimal mode also can be based on the present location of the contact, the contacts presence information, the configuration of the first communication device, and/or any other information that may be relevant to selecting a mode of communication.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

1. A method of providing device capability information, comprising:
receiving from a first communication device at least a first identifier that indicates functional capabilities of the first communication device; and
automatically associating in an address book the functional capabilities of the first communication device with a contact with whom the first device is associated.

2. The method of claim 1, wherein receiving the first identifier comprises receiving an identifier that indicates a communication device model.

3. The method of claim 2, further comprising:
retrieving the functional capability information based on the indicated communication device model.

4. The method of claim 1, further comprising selecting a mode of communication to use to communicate with the first communication device based on the first identifier.

5. The method of claim 1, further comprising:
communicating a message to the first communication device to request the first identifier;
wherein the first identifier is communicated by the first communication device in response to the communicated message.

6. The method of claim 1, wherein receiving from the first communication device the first identifier comprises receiving the first identifier during call setup of the first communication device.

7. The method of claim 1, further comprising:
receiving at least a second identifier that identifies a location of the first communication device; and
selecting a mode of communication to use to communicate with the first communication device based on at least the first identifier and the second identifier.

8. The method of claim 1, wherein associating the functional capabilities of the first communication device with the contact comprises associating the functional capabilities with the contact in a network address book.

9. The method of claim 8, further comprising communicating the functional capabilities to a second communication device.

10. The method of claim 9, wherein communicating the functional capabilities to the second communication device comprises communicating the functional capabilities during call setup of the second communication device.

11. The method of claim 9, wherein communicating the functional capabilities to the second communication device comprises communicating the functional capabilities as an update to existing information contained on the second communication device.

12. The method of claim 1, further comprising automatically associating in the address book the functional capabilities of the first communication device with equivalent devices.

13. The method of claim 1, further comprising:
receiving from the first communication device at least one type of information selected from the group consisting of location information, presence information and configuration information; and
automatically associating the information with the contact.

14. A method of providing device capability information, comprising:
responsive to an event, determining whether a first communication device is authorized to receive a first identifier that indicates functional capabilities of a second communication device; and
responsive to determining that the first communication device is authorized to receive the first identifier, automatically communicating the first identifier to the first communication device.

15. The method of claim 14, wherein communicating the first identifier comprises communicating the first identifier in response to a request received from the first communication device.

16. The method of claim 14, wherein communicating the first identifier comprises communicating the first identifier during call setup of the second communication device.

17. The method of claim 14, further comprising:
communicating to the first communication device at least a second identifier that identifies a location of the second communication device.

18. The method of claim 14, wherein communicating the first identifier to the first communication device comprises communicating the first identifier from a server associated with a network address book.

19. A communication device, comprising:
at least one communications adapter that receives from a second communication device at least a first identifier that indicates functional capabilities of the second communication device; and
a controller that automatically associates in an address book the functional capabilities of the second communication device with a contact with whom the second communication device is associated.

20. The communication device of claim 19, wherein the communication device selects a mode of communication to use to communicate with the second communication device based on the first identifier.

21. The communication device of claim 19, wherein the communications adapter communicates a message to the second communication device to request the first identifier, and the first identifier is communicated by the second communication device in response to the communicated message.

22. The communication device of claim 19, wherein the communications adapter receives at least a second identifier that identifies a location of the second communication device, and the controller selects a mode of communication to use to communicate with the second communication device based on at least the first identifier and the second identifier.

23. The communication device of claim 19, wherein associating the functional capabilities of the first communication device with the contact comprises associating the functional capabilities with the contact in a network address book.
